(19) United States
(12) Patent Application Publication
(10) Pub. No.: US 2023/0065789 A1
(43) Pub. Date: Mar. 2, 2023

(54) GAS DIFFUSION LAYER FOR FUEL CELL INCLUDING CARBOXYMETHYL CELLULOSE AND MEHTOD FOR PRODUCING THE SAME

(71) Applicants: Hyundai Motor Company, Seoul (KR); Kia Corporation, Seoul (KR)

(72) Inventors: Seung Tak NOH, Suwon-si (KR); Seung Hun KANG, Yongin-si (KR); Ji Han LEE, Seongnam-si (KR); Jae Man PARK, Yongin-si (KR)

(73) Assignees: Hyundai Motor Company, Seoul (KR); Kia Corporation, Seoul (KR)

(21) Appl. No.: 17/736,221

(22) Filed: May 4, 2022

(30) Foreign Application Priority Data
Aug. 26, 2021 (KR) 10-2021-0113504

(51) Int. Cl. H01M 8/0245; H01M 8/0239; H01M 8/1004

(52) U.S. Cl. CPC H01M 8/0245; H01M 8/0239; H01M 8/1004

(57) ABSTRACT

A method for producing a gas diffusion layer for a fuel cell, includes a substrate preparation step of preparing a substrate for the gas diffusion layer; a slurry preparation step of preparing a slurry for a microporous layer containing carboxymethyl cellulose (CMC) and polytetrafluoroethylene (PTFE) diffused in solvent; a microporous layer forming step of forming a microporous layer by applying the slurry onto the substrate; and a heat-treatment step of controlling the hydrophobicity of the gas diffusion layer by heating the substrate having the microporous layer applied thereonto. Also disclosed is a gas diffusion layer produced thereby. The method may control the hydrophobicity of the gas diffusion layer by variably controlling the heat-treatment temperature.

### CROSS-REFERENCE TO RELATED APPLICATION(S)

The present application claims priority to Korean Patent Application No. 10-2021-0113504, filed on Aug. 26, 2021, the entire contents of which is incorporated herein for all purposes by this reference.

### BACKGROUND OF THE PRESENT DISCLOSURE

### Field of the Present Disclosure

The present disclosure relates to a gas diffusion layer for a fuel cell and a method for producing the same, and more particularly, to a method for producing a gas diffusion layer for a fuel cell, which may variably control the hydrophobicity of the gas diffusion layer by adjusting a process control variable, and a gas diffusion layer for a fuel cell produced thereby.

### Description of Related Art

A fuel cell is a kind of power generation device that converts chemical energy of fuel into electrical energy by an electrochemical reaction in a stack. The fuel cell may be used not only to supply driving power to industrial devices, household appliances and vehicles, but also to supply power to small electronic products such as portable devices, and the use thereof as a high-efficiency clean energy source has been gradually expanded in recent years.

FIG. 1 is a view showing a unit cell of a typical fuel cell, and FIG. 2 is a sectional view showing a gas diffusion layer of a typical fuel cell.

As can be seen in FIG. 1, a membrane electrode assembly 10 (MEA) is located in the innermost portion of the unit cell of a typical fuel cell. The present membrane electrode assembly is composed of a polymer electrolyte membrane 11, which allows protons to move therethrough, and catalyst layers, that is, an anode electrode layer 12 and a cathode electrode layer 13, formed on both sides of the electrolyte membrane so that hydrogen and oxygen can react.

Furthermore, gas diffusion layers 20 (GDL) are stacked outside the membrane electrode assembly 10, that is, outside the portions where the anode electrode layer 12 and the cathode electrode layer 13 are located. Furthermore, outside the gas diffusion layers 20, separators 30 having a flow field formed therein are located to supply fuel and discharge water produced by the reaction.

As shown in FIG. 2, the gas diffusion layer 20 is produced by forming a microporous layer (MPL) on a substrate 21 made of carbon fiber.

Furthermore, the substrate 21 is generally composed of carbon fiber impregnated with a hydrophobic agent such as polytetrafluoroethylene (PTFE). For example, as the carbon fiber, carbon fiber cloth, carbon fiber felt or carbon fiber paper may be used.

Furthermore, the microporous layer 22 may be produced by mixing carbon powder, such as carbon black, acetylene black carbon or black pearls carbon, with a hydrophobic agent such as polytetrafluoroethylene (PTFE), and then applied to one or both surfaces of the substrate 21 in accordance with the intended use.

Meanwhile, in the anode electrode layer 12, the oxidation reaction of hydrogen occurs to generate protons and electrons. The generated protons and electrons move to the cathode electrode layer 13 through the polymer electrolyte membrane 11 and an electric wire, respectively. In the cathode electrode layer 13, electrical energy is produced from the flow of the electrons while water is produced through an electrochemical reaction in which the protons and electrons that moved from the anode electrode layer 12 and oxygen of the air participate.

Furthermore, the reactant gases provided to the fuel cell and the liquid-phase product water generated by the chemical reaction are discharged while they move from the cathode electrode layer 13 of the membrane electrode assembly 10 in the direction of the microporous layer 22 and substrate 21 of the gas diffusion layer 20 and the separator 30.

Specifically, the gas diffusion layer (GDL) may be made of hydrophobically treated carbon paper or felt, and serves various roles in the stack, such as supplying the reactant gases, protecting the membrane electrode assembly, and discharging the product water. The gas diffusion layer (GDL) has excellent gas permeability so that hydrogen and air may be efficiently supplied to the electrode through the gas diffusion layer, and the carbon fiber substrate has an elasticity and mechanically protects the membrane electrode assembly. Furthermore, since the gas diffusion layer contains a hydrophobic agent (PTFE), it has a property of not getting wet with water, and water may be removed from the membrane electrode assembly through the pores and cracks of the microporous layer and the space in the substrate.

Meanwhile, a suitable fuel cell operating region may vary depending on the degree to which the gas diffusion layer is hydrophobically treated. For example, a gas diffusion layer treated to have high hydrophobicity has an excellent water discharge property, and thus is advantageous for low-temperature/high-humidity operating conditions, and a gas diffusion layer treated to have low hydrophobicity has moisture permeability, and thus is advantageous for high-temperature/low-humidity operating conditions. The hydrophobicity is affected by the composition of the microporous layer (MPL), but the method of changing the present composition is very difficult in terms of cost and time.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for producing a gas diffusion layer for a fuel cell, which may effectively change and control the hydrophobicity of the gas diffusion layer by changing a process control variable while maintaining the equipment for the gas diffusion layer production process as it is, and a gas diffusion layer for a fuel cell produced thereby.

Another object of the present disclosure is to improve the performance of a fuel cell stack by stacking unit cells including a gas diffusion layer for high humidity condition and unit cells including a gas diffusion layer for low humidity condition separately depending on the hydrophobic performance required for each cell location in the fuel cell stack.

To achieve the above objects, according to an exemplary embodiment of the present disclosure, there is provided a method for producing a gas diffusion layer for a fuel cell, the method including: a substrate preparation step of preparing a substrate for the gas diffusion layer; a slurry preparation step of preparing a slurry for a microporous layer containing carboxymethyl cellulose (CMC) and polytetrafluoroethylene (PTFE) dispersed in solvent; a microporous layer forming step of forming a microporous layer by applying the slurry onto the substrate; and a heat-treatment step of controlling the hydrophobicity of the gas diffusion layer by heating the substrate having the microporous layer applied thereonto.

The heat-treatment temperature in the heat-treatment step may be controlled to a temperature of 300 to 325° C. to produce a gas diffusion layer for low humidity condition.

Furthermore, the heat-treatment temperature in the heat-treatment step may be controlled to a temperature of 350 to 380° C. to produce a gas diffusion layer for high humidity condition.

The slurry preparation step may include preparing the slurry for a microporous layer by dispersing CMC and then dispersing PTFE.

The slurry preparation step may include steps of: preparing a solvent containing carbon black together with a dispersing agent dispersed therein; dispersing the CMC in the solvent; and dispersing the PTFE in the solvent containing the CMC dispersed therein to obtain the slurry.

The slurry may contain 1 wt % to 2 wt % of CMC and 10 wt % to 40 wt % of PTFE.

According to another exemplary embodiment of the present disclosure, there is provided a gas diffusion layer for a fuel cell including: a substrate layer; and a microporous layer formed by applying a slurry containing carboxymethyl cellulose (CMC) and polytetrafluoroethylene (PTFE) to a surface of the substrate layer.\

The substrate layer may be composed of a carbon fiber-based substrate, and the microporous layer may be a microporous layer whose hydrophobicity has been controlled by heat treatment at a predetermined temperature.

The microporous layer may be a gas diffusion layer for low humidity condition heat-treated at a temperature of 300° C. to 325° C., or a gas diffusion layer for high humidity condition heat-treated at a temperature of 350° C. to 380° C.

The slurry may be a slurry for a microporous layer prepared by dispersing CMC and then dispersing PTFE. The slurry may be a slurry for a microporous layer prepared through steps of: preparing a solvent containing carbon black together with a dispersing agent dispersed therein; dispersing the CMC in the solvent; and dispersing the PTFE in the solvent containing the CMC dispersed therein to obtain the slurry.

The slurry may contain 1 wt % to 2 wt % CMC and 10 wt % to 40 wt % PTFE.

According to various exemplary embodiments of the present disclosure, there is provided a fuel cell stack formed by stacking a plurality of unit cells each including: a membrane electrode assembly (MEA); a pair of gas diffusion layers which are respectively in contact with one surface and the other surface of the membrane electrode assembly; and a pair of separators which are respectively in contact with the external surfaces of the gas diffusion layers, the fuel cell stack including: a first group of unit cells, which are sequentially stacked at one end corresponding to a hydrogen and air inlet side; and a second group of unit cells, which are sequentially stacked at another end corresponding to a side opposite to the hydrogen and air inlet side, wherein each of the unit cells in the first group and the unit cells in the second group includes a microporous layer formed by applying a slurry containing carboxymethyl cellulose (CMC) and polytetrafluoroethylene (PTFE) to a surface of a substrate layer, and the microporous layers of the unit cells in the first group have been heat-treated at a temperature different from a heat-treatment temperature of the microporous layers of the unit cells in the second group.

The microporous layers of the unit cells in the first group may be microporous layers for high humidity condition heat-treated at a temperature of 350° C. to 380° C., and the microporous layers of the unit cells in the second group may be gas diffusion layers for low humidity condition heat-treated at a temperature of 300° C. to 325° C.

Unit cells of a third group may be stacked between the unit cells of the first group and the unit cells of the second group, and each of the unit cells of the third group may include a microporous layer formed by applying a slurry containing carboxymethyl cellulose (CMC) and polytetrafluoroethylene (PTFE) on a surface of a substrate layer and heat-treated at a temperature ranging from higher than 325° C. to lower than 350° C.

The methods and apparatuses of the present disclosure have other features and advantages which will be apparent from or are set forth in more detail in the accompanying drawings, which are incorporated herein, and the following Detailed Description, which together serve to explain predetermined principles of the present disclosure.

### BRIEF DESCRIPTION OF THE DRAWINGS

FIG. 1 is a view showing a unit cell of a typical fuel cell.

FIG. 2 is a sectional view showing a gas diffusion layer for a typical fuel cell.

FIG. 3 is a view showing a process for producing a gas diffusion layer for a fuel cell containing CMC according to an exemplary embodiment of the present disclosure.

FIG. 4A is a sectional view showing a gas diffusion layer for low humidity condition produced according to an exemplary embodiment of the present disclosure, and FIG. 4B is a sectional view showing a gas diffusion layer for high humidity condition produced according to an exemplary embodiment of the present disclosure.

FIG. 5 is a conceptual view exemplarily illustrating an example of a fuel cell stack in which cells including gas diffusion layers having different hydrophobic performances are stacked at different locations.

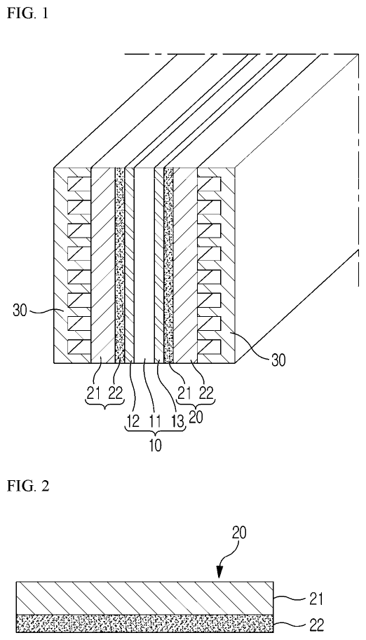

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a gas diffusion layer for a fuel cell and a production method therefore according to an exemplary embodiment of the present disclosure will be described in detail with reference to the accompanying drawings.

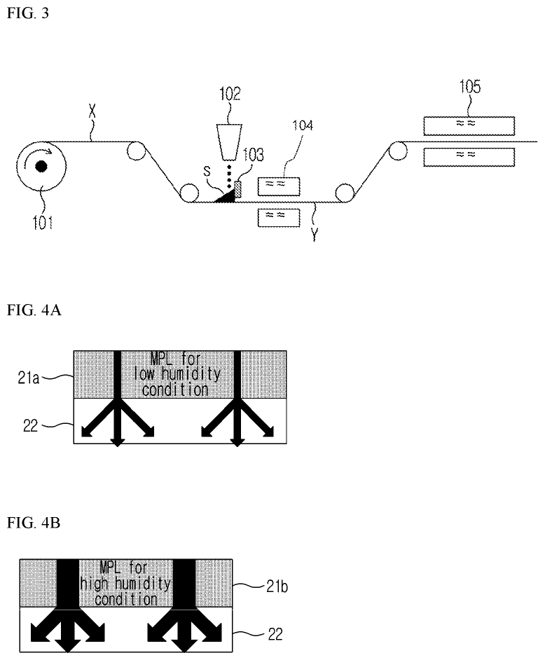

FIG. 3 is a view showing a process for producing a gas diffusion layer for a fuel cell containing CMC according to an exemplary embodiment of the present disclosure, FIG. 4A is a sectional view showing a gas diffusion layer for low humidity condition, produced according to an exemplary embodiment of the present disclosure, and FIG. 4B is a sectional view showing a gas diffusion layer for high humidity condition, produced according to an exemplary embodiment of the present disclosure.

As shown in FIG. 4A and FIG. 4B, the gas diffusion layer for a fuel cell according to an exemplary embodiment of the present disclosure includes a substrate layer 22, and a microporous layer 21a or 21b stacked on the substrate layer, and the present stack structure is the same as the structure of the conventional gas diffusion layer shown in FIG. 2. However, an exemplary embodiment of the present disclosure is characterized in that the microporous layers 21a and 21b having different hydrophobicity are formed, even though the microporous layers are formed by the slurry having the same composition. In this regard, FIG. 4A and FIG. 4B respectively show an example in which the water discharge property is enhanced (FIG. 4A) and an example in which the water discharge property is suppressed (FIG. 4B), as the hydrophobicity changes depending on the process characteristics.

In relation to the configuration of the present gas diffusion layer, as the base layer 22, hydrophobically treated carbon paper or felt may be used, which is a substrate including carbon fiber, which is widely used in a conventional art.

Meanwhile, the microporous layer 21a or 21b stacked on the surface of the substrate layer is formed by applying a slurry including carboxymethyl cellulose (CMC) and polytetrafluoroethylene (PTFE). The hydrophobicity of the microporous layer 21a or 21b may be adjusted by controlling a process variable. Specifically, the hydrophobicity may be controlled by heat-treating the microporous layer at a predetermined temperature depending on the required hydrophobic performance.

This microporous layer may be produced from a slurry containing carbon powder, CMC and PTFE dispersed therein. As the carbon powder contained in the present slurry, carbon powders such as carbon black, acetylene black carbon, and black pearls carbon, may be used alone or as a mixture. In an example of the present disclosure, carbon black was used as the carbon powder.

This carbon powder is dispersed in a solvent together with a dispersing agent, and CMC and PTFE are further dispersed to control hydrophobicity. As a solvent which is used to prepare the slurry, isopropyl alcohol (IPA), n-propyl alcohol (NPA), DI water, etc. may be used.

As one of the hydrophobicity controlling materials dispersed in the slurry, carboxymethyl cellulose (CMC) may be used. CMC (typically an alkali metal salt, for example, a sodium salt) is a cellulose derivative, and is generally used as a binder or thickener in the fabrication of lithium secondary batteries. The CMC used herein is not limited to a specific CMC with a particular weight-average molecular weight (Mw), and any commonly used CMC may be used without particular limitation. However, CMC, a hydrophilic material, should be able to be deactivated (decomposed) within a specific temperature range, and in the present disclosure, the temperature range in which the decomposition of CMC is suppressed should not overlap with the temperature range in which PTFE is activated.

Polytetrafluoroethylene (PTFE) is generally used as a hydrophobic agent which is added to facilitate the discharge of water produced in the stack. In the present disclosure, PTFE is dispersed in the slurry together with CMC and contained in the microporous layer. The present PTFE provides hydrophobicity as opposed to CMC. Specifically, PTFE is used to impart hydrophobicity to the microporous layer, unlike CMC which is hydrophilic. Thus, PTFE and CMC are activated in different temperature ranges. The hydrophobic material PTFE is activated at 350° C. or higher, and deactivation (decomposition) of the hydrophilic material CMC is suppressed in the range of 300° C. to 325° C.

Regarding the hydrophobicity of the gas diffusion layer, the fact that PTFE and CMC, which can give two opposing functions, are activated or deactivated in different temperature ranges is very important in that it is possible to impart different hydrophobicity to the gas diffusion layers by changing and controlling the heat treatment temperature in the process.

The composition constituting the microporous layer according to an exemplary embodiment of the present disclosure may be composed of carbon black, a solvent, a dispersing agent, PTFE (hydrophobic agent), and CMC (hydrophilic material). To the present end, the slurry which is used to form the microporous layer by coating may be prepared by preparing a solvent containing carbon black together with a dispersing agent dispersed therein, and then sequentially dispersing CMC and PTFE in the solvent, and the microporous layer may be stacked by applying the prepared slurry to a surface of the substrate layer.

At the present time, as materials constituting the slurry for a microporous layer (MPL), as described above, carbon black, a solvent, a dispersing agent, PTFE and CMC may be used. In particular, PTFE may be contained in an amount of 10 wt % to 40 wt %, and CMC may be contained in an amount of 1 wt % to 2 wt %. Among them, with respect to the range of CMC, when CMC is excessively contained in the slurry, the viscosity of the slurry may increase so that the coatability and dispersibility thereof may decrease, and the porosity of the microporous layer structure may decrease. For the present reason, the content of CMC is limited to 2 wt % or less. On the other hand, when CMC is contained in the slurry in an amount of less than 1 wt %, the effect of increasing the viscosity and providing phase stability is reduced. Other materials constituting the slurry composition may be appropriately selected depending on the contents (wt %) of PTFE and CMC, and can be determined similarly to the general composition range of a solvent for PTFE coating for forming the microporous layer, carbon black, and a dispersing agent.

Meanwhile, according to an exemplary embodiment of the present disclosure, the dispersion order for preparing the slurry for a microporous layer is the order of “carbon black, the dispersing agent and the solvent→CMC→PTFE”.

In this regard, it is important that the CMC dispersing step must be done first before the step of dispersing PTFE. Furthermore, after mixing of carbon black, the dispersing agent and the solvent, CMC is added. Thus, the carbon-dispersing agent-solvent should be configured to be preferentially dispersed in CMC. This is because CMC has a property of absorbing water when in contact with water, and thus when CMC is added together with carbon black, a problem arises in that dispersion of carbon black is not smooth.

Furthermore, CMC should be added prior to PTFE addition in order to effectively disperse CMC in the slurry. In order to efficiently disperse the CMC in the slurry for a microporous layer, high rotational and shear forces should be applied to the mixture. Meanwhile, PTFE is a resin having a property of hardening when strong shear and rotational forces are applied thereto. Thus, when PTFE and CMC are mixed together and strongly rotated and dispersed, the PTFE hardens in the slurry and the flowability of the slurry decreases, and thus the coatability of the microporous layer deteriorates.

Therefore, according to an exemplary embodiment of the present disclosure, the slurry for a microporous layer is previously prepared through sequential steps of: preparing a solvent containing carbon black together with a dispersing agent dispersed therein; dispersing the CMC in the solvent; and dispersing the PTFE in the solvent containing the CMC dispersed therein to obtain the slurry.

Furthermore, in an exemplary embodiment of the present disclosure, the microporous layer slurry containing PTFE and CMC dispersed together therein is used to adjust hydrophobicity by controlling a process variable, and the controllable process variable at the instant time is the temperature condition in the heat treatment process.

In this regard, in a process of producing the gas diffusion layer, the temperature of the heat-treatment process which is performed after the surface of the substrate layer is coated with the microporous layer plays an important role.

For example, in order to provide excellent water discharge properties (low temperature and high humidity properties), the hydrophobic effect may be maximized by setting the heat treatment temperature to 350° C. or higher. On the other hand, when water should be relatively confined (high temperature and low humidity properties), the heat treatment temperature may be set to a range of 300° C. to 325° C. to reduce the hydrophobic effect and maximize the hydrophilic effect.

As described above, the present characteristic is related to the activation/deactivation temperature of the material. This is because PTFE, a hydrophobic material, is activated at 350° C. or higher, and the deactivation (decomposition) of CMC, a hydrophilic material, is suppressed in the range of 300° C. to 325° C. Thus, in order to produce a microporous layer for high humidity condition (or a gas diffusion layer for high humidity condition), the heat treatment process is performed at 350° C. or higher, preferably 350° C. to 380° C., which is the activation temperature of PTFE. On the other hand, in order to produce a microporous layer for low humidity condition (or a gas diffusion layer for low humidity condition), the heat treatment process is performed in the range of 300° C. to 325° C., which is the temperature range in which the decomposition of CMC is suppressed. Thus, the hydrophilic effect of CMC is maximized in the temperature range that does not reach the activation temperature of PTFE.

Thus, the microporous layer 21a in FIG. 4A may be a gas diffusion layer 21a for low humidity condition, subjected to low-temperature heat treatment at a temperature of 300° C. to 325° C., and the microporous layer 21b in FIG. 4B may be a gas diffusion layer 21b for high humidity condition, subjected to high-temperature heat treatment at a temperature of 350° C. to 380° C. The gas diffusion layer produced through a heat treatment process depending on the required hydrophobic performance may be stacked and utilized to suit a unit cell having the required specification.

A method for producing a gas diffusion layer for a fuel cell according to an exemplary embodiment of the present disclosure includes: a substrate preparation step of preparing a substrate for the gas diffusion layer; a slurry preparation step of preparing a slurry for a microporous layer containing carboxymethyl cellulose (CMC) and polytetrafluoroethylene (PTFE) dispersed in solvent; a microporous layer forming step of forming a microporous layer by applying the slurry onto the substrate; and a heat-treatment step of heating the substrate having the microporous layer applied thereonto to control the hydrophobicity of the gas diffusion layer.

The heat treatment temperature in the heat-treatment step may be controlled to a temperature of 300° C. to 325° C. to produce a gas diffusion layer for low humidity condition. In another exemplary embodiment of the present disclosure, the heat treatment temperature in the heat-treatment step may be controlled to a temperature of 350° C. to 380° C. to produce a gas diffusion layer for high humidity condition.

A method for producing a gas diffusion layer for a fuel cell according to an exemplary embodiment of the present disclosure will now be described in detail with reference to FIG. 3. FIG. 3 schematically shows the method for producing a gas diffusion layer for a fuel cell according to an exemplary embodiment of the present disclosure, which includes a process of coating a previously prepared substrate layer with a microporous layer and controlling the hydrophobicity of the microporous layer through subsequent heat treatment.

In this regard, in the example shown in FIG. 3, the detailed process related to the preparation of the substrate layer is not shown, and the entire process including supplying the previously prepared substrate layer fabric is shown. However, the present example is intended to describe in detail the hydrophobicity control step that needs to be described in detail among steps of the method for producing a gas diffusion layer for a fuel cell according to an exemplary embodiment of the present disclosure, and the present example means that there is no particular limitation on the method of preparing the substrate layer.

Furthermore, the process view of FIG. 3 illustrates an example in which a substrate layer X is supplied to a microporous layer coating equipment side 102, 103 while it is unwound from a unwinder 101 on which a previously provided substrate layer fabric is wound, but the present disclosure is not limited to the present example, and naturally includes process examples integrally and inseparably combined with a series of processes such as carbon fiber paper production, resin impregnation, and carbonization.

As shown in FIG. 3, according to an exemplary embodiment of the present disclosure, a slurry for a microporous layer containing carbon black, a solvent, a dispersing agent, PTFE (hydrophobic agent), and CMC (hydrophilic material) may be supplied through a slurry supply unit 102, and may be applied onto a substrate layer X to a predetermined thickness through a scraper 103. In this regard, the slurry for a microporous layer is a slurry for a microporous layer previously prepared through the slurry preparation steps described above. According to an exemplary embodiment of the present disclosure, the slurry is a slurry for a microporous layer obtained by dispersing carbon black together with a dispersing agent in a solvent, and then dispersing CMC, and then finally dispersing PTFE. In this regard, the prepared slurry may be applied to the surface of the substrate layer by a doctor blade method.

After the slurry is applied to the surface of the substrate layer to a predetermined thickness, the solvent of the applied slurry is vaporized by passage through a dryer 104. Thereafter, the substrate layer Y having the microporous layer applied thereto is supplied to a heat treatment device 105. The microporous layer is hardened while being subjected to a heat treatment process by the heat treatment device 105, and thus the production of the gas diffusion layer including the microporous layer stacked on the substrate layer is completed.

As described above, the hydrophobicity of the microporous layer may be controlled by controlling the process variable, that is, the heat-treatment temperature, in the heat treatment process. When the heat-treatment temperature is 350° C. or higher, preferably a temperature of 350° C. to 380° C., which corresponds to a temperature condition where PTFE activation and CMC decomposition are possible, the hydrophobic effect is enhanced. Accordingly, a gas diffusion layer advantageous for low temperature/high humidity operating conditions, that is, a gas diffusion layer for high humidity condition (a microporous layer for high humidity condition), is produced. This gas diffusion layer is suitable for operation in a stack temperature range of 20° C. to 30° C. and a relative humidity range of 80% to 100%. Thus, when the present gas diffusion layer for high humidity condition is applied to a single stack, it is advantageous for a hydrogen/air supply part (cell No. 1) with relatively little water.

Meanwhile, when the heat-treatment temperature is controlled within the range of 300° C. to 325° C., which corresponds to a temperature condition in which suppression of PTFE activation and suppression of CMC decomposition are possible, the hydrophilic effect is enhanced. Accordingly, a gas diffusion layer advantageous for high temperature/low humidity operating conditions, that is, a gas diffusion layer for low humidity condition (a microporous layer for low humidity condition), is produced. The present gas diffusion layer is suitable for operation in a stack temperature range of 70° C. to 80° C. and a relative humidity range of 20% to 40%. Thus, when the present gas diffusion layer for low humidity condition is applied to a single stack, it is advantageous for the rear end portion (end cell) where a relatively large amount of water is accumulated.

According to an exemplary embodiment of the present disclosure, the hydrophobicity may be changed by controlling a temperature variable without a special process change, and thus the gas diffusion layer may be made hydrophobic or hydrophilic by appropriately setting the heat-treatment process temperature. Through the present control, the water content of the membrane electrode assembly in the stack may be effectively controlled by imparting hydrophobicity to a gas diffusion layer for operation under high humidity conditions and imparting hydrophilicity to a gas diffusion layer for operation under low humidity conditions.

Furthermore, CMC, a hydrophilic material, serves as a thickener, and may exert a phase stability effect that makes the viscosity of the slurry for a microporous layer unchanged with time. Therefore, when the slurry containing CMC dispersed therein is used, an additional effect of making the coating quality of the microporous layer constant may be obtained.

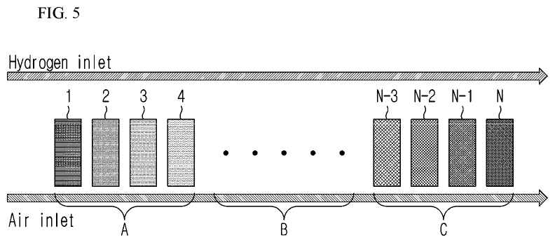

FIG. 5 is a conceptual view exemplarily illustrating an example of a fuel cell stack in which cells including gas diffusion layers having different hydrophobic performances are stacked at different locations.

As is well known, a fuel cell stack is formed by stacking a plurality of unit cells in order to generate sufficient power. In particular, each of the unit cells includes: a membrane electrode assembly (MEA); a pair of gas diffusion layers which are respectively in contact with one surface and the other surface of the membrane electrode assembly; and a pair of separators which are respectively in contact with the external surfaces of the gas diffusion layers.

For example, in the case of a fuel cell stack in which N unit cells (N is an integer of 2 or more, preferably N=440) are repeatedly stacked, a non-uniform distribution of reactant gases (hydrogen and air) inevitably exists due to the nature of the fuel cell stack. Furthermore, a difference in gas supply pressure leads to a difference in the tendency to discharge produced water and a difference in the relative humidity in the cell.

Meanwhile, the fuel cell stack according to an exemplary embodiment of the present disclosure is characterized in that the gas diffusion layers heat-treated at different temperatures are applied in order to resolve the imbalance inside the stack. That is, as the heat-treatment temperature in a process of producing the gas diffusion layer is controlled as described above, the hydrophilic/hydrophobic tendency of the gas diffusion layer may be appropriately changed and controlled, compensating for the difference in the relative humidity in the cell due to the imbalance inside the stack.

For example, FIG. 5 shows an example of a fuel cell stack formed by stacking N unit cells. In the present example, the unit cells may be numbered 1 to N starting from the hydrogen and air inlet side. That is, when the outermost unit cell at the hydrogen and air inlet side is referred to as cell No. 1, the other unit cells may be referred to as cell No. 2, cell No. 3, cell No. 4. cell No. N−3, cell No. N−2, cell No. N−1, and cell No. N sequentially in the stacking direction. When cell No. N is an end cell, cell No. 1 is under the driest condition, and the end cell is under the wettest condition. Thus, as cell No. 1 which is under the driest condition, a unit cell including gas diffusion layers for high humidity condition subjected to high-temperature heat treatment is suitable. On the other hand, as an end cell which is under the wettest condition, a unit cell including gas diffusion layers for low humidity condition subjected to low-temperature heat treatment is suitable.

Accordingly, the fuel cell stack according to an exemplary embodiment of the present disclosure is characterized in that the unit cells are divided into unit cells (e.g., cell Nos. 1 to 4) in a first group A, which are sequentially stacked at one end corresponding to the hydrogen and air inlet side, and unit cells (e.g., cell Nos. N−3 to N) in a second group C, which are sequentially stacked at another end corresponding to the side opposite to the hydrogen and air inlet side, and the microporous layers of the unit cells in the first group A are heat-treated at a temperature different from the heat-treatment temperature of the microporous layers of the unit cells in the second group C so that the microporous layers have different hydrophobic performances.

In the instant case, the microporous layers of the unit cells in the first group A may be microporous layers for high humidity condition heat-treated at a temperature of 350° C. to 380° C., and the microporous layers of the unit cells in the second group C may be gas diffusion layers for low humidity condition heat-treated at a temperature of 300° C. to 325° C.

Furthermore, between the unit cells in the first group A and the unit cells in the second group C, unit cells (cell Nos. 5 to N−4) in a third group B are stacked. The unit cells in the third group B may include gas diffusion layers whose heat treatment temperature has been controlled in the same manner as the above-described unit cells. In the instant case, the unit cells in the third group B, which are stacked in the middle, may have a heat treatment temperature range between the upper limit of the temperature range for the second group C and the lower limit of the temperature range for the first group A.

That is, since the unit cells in the third group B located in the middle should have characteristics intermediate to those of cell No. 1 and the end cell, they may preferably be unit cells including microporous layers heat-treated in the intermediate temperature range, that is, a temperature ranging from higher than 325° C. to lower than 350° C.

As described above, according to the gas diffusion layer for a fuel cell including carboxymethyl cellulose (CMC) and the method for producing the same according to an exemplary embodiment of the present disclosure, it is possible to effectively change the hydrophobicity of the gas diffusion layer by selectively controlling the temperature variable in the process without changing special process equipment.

Therefore, according to an exemplary embodiment of the present disclosure, it is possible to reduce the cost for producing a multi-type gas diffusion layer for a fuel cell, and to simplify the production line and improve productivity by reducing the recipe process. In particular, according to an exemplary embodiment of the present disclosure, as the heat-treatment process temperature is appropriately set between the activation temperature of the hydrophobic agent PTFE and 325 to 350° C., which is the decomposition temperature of the hydrophilic material CMC, it is possible to selectively produce a hydrophobic gas diffusion layer or a hydrophilic gas diffusion layer. In conclusion, there is an advantage in that it is possible to fabricate a fuel cell stack in which the relative humidity in the membrane electrode assembly may be effectively controlled by controlling the temperature variable in the process.

Furthermore, according to the gas diffusion layer for a fuel cell including CMC and the method for producing the same according to an exemplary embodiment of the present disclosure, the hydrophilic material CMC serving as a thickener may provide a phase stabilization effect that makes the viscosity of the slurry for a microporous layer unchanged with time, providing an effect of making the coating quality of the microporous layer constant. Accordingly, there is an advantage in that it is possible to effectively control the thickness and illuminance of the gas diffusion layer.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for producing a gas diffusion layer for a fuel cell, the method comprising:
a substrate preparation step of preparing a substrate for the gas diffusion layer;
a slurry preparation step of preparing a slurry for a microporous layer containing carboxymethyl cellulose (CMC) and polytetrafluoroethylene (PTFE) dispersed in solvent;
a microporous layer forming step of forming a microporous layer by applying the slurry onto the substrate; and
a heat-treatment step of controlling hydrophobicity of the gas diffusion layer by heating the substrate having the microporous layer applied thereonto.

2. The method of claim 1, wherein a heat-treatment temperature in the heat-treatment step is controlled to a temperature of 300 to 325° C. to produce a gas diffusion layer for low humidity condition.

3. The method of claim 1, wherein a heat-treatment temperature in the heat-treatment step is controlled to a temperature of 350 to 380° C. to produce a gas diffusion layer for high humidity condition.

4. The method of claim 1, wherein the slurry preparation step includes preparing the slurry for a microporous layer by dispersing CMC and then dispersing PTFE.

5. The method of claim 1, wherein the slurry preparation step includes steps of:
preparing a solvent containing carbon black together with a dispersing agent dispersed therein;
dispersing the CMC in the solvent; and
dispersing the PTFE in the solvent containing the CMC dispersed therein to obtain the slurry.

6. The method of claim 1, wherein the slurry contains 1 wt % to 2 wt % of the CMC and 10 wt % to 40 wt % of the PTFE.

7. A gas diffusion layer for a fuel cell, the diffusion layer comprising:
a substrate layer; and
a microporous layer formed by applying a slurry containing carboxymethyl cellulose (CMC) and polytetrafluoroethylene (PTFE) to a surface of the substrate layer.

8. The gas diffusion layer of claim 7, wherein the substrate layer is composed of a carbon fiber-based substrate.

9. The gas diffusion layer of claim 7, wherein the microporous layer is a microporous layer whose hydrophobicity has been controlled by heat treatment at a predetermined temperature.

10. The gas diffusion layer of claim 9, wherein the microporous layer is a gas diffusion layer for low humidity condition heat-treated at a temperature of 300° C. to 325° C.

11. The gas diffusion layer of claim 9, wherein the microporous layer is a gas diffusion layer for high humidity condition heat-treated at a temperature of 350° C. to 380° C.

12. The gas diffusion layer of claim 7, wherein the slurry is a slurry for a microporous layer prepared by dispersing the CMC and then dispersing the PTFE.

13. The gas diffusion layer of claim 7, wherein the slurry is a slurry for a microporous layer prepared through steps of:
preparing a solvent containing carbon black together with a dispersing agent dispersed therein;
dispersing the CMC in the solvent; and
dispersing the PTFE in the solvent containing the CMC dispersed therein to obtain the slurry.

14. The gas diffusion layer of claim 7, wherein the slurry contains 1 wt % to 2 wt % of the CMC and 10 wt % to 40 wt % of the PTFE.

15. A fuel cell stack formed by stacking a plurality of unit cells each comprising: a membrane electrode assembly (MEA); a pair of gas diffusion layers which are respectively in contact with a first surface and a second surface of the membrane electrolyte assembly; and a pair of separators which are respectively in contact with external surfaces of the gas diffusion layers, the fuel cell stack comprising:
a first group of unit cells, which are sequentially stacked at one end corresponding to a hydrogen and air inlet side; and
a second group of unit cells, which are sequentially stacked at another end corresponding to a side opposite to the hydrogen and air inlet side,
wherein each of the unit cells in the first group and the unit cells in the second group includes a microporous layer formed by applying a slurry containing carboxymethyl cellulose (CMC) and polytetrafluoroethylene (PTFE) to a surface of a substrate layer, and
wherein the microporous layers of the unit cells in the first group have been heat-treated at a temperature different from a heat-treatment temperature of the microporous layers of the unit cells in the second group.

16. The fuel cell stack of claim 15,
wherein the microporous layers of the unit cells in the first group are microporous layers for high humidity condition heat-treated at a temperature of a first lower limit to a first upper limit, and
wherein the microporous layers of the unit cells in the second group are gas diffusion layers for low humidity condition heat-treated at a temperature of a second lower limit to a second upper limit.

17. The fuel cell stack of claim 16,
wherein unit cells in a third group are stacked between the unit cells in the first group and the unit cells in the second group, and
wherein each of the unit cells in the third group includes a microporous layer formed by applying a slurry containing carboxymethyl cellulose (CMC) and polytetrafluoroethylene (PTFE) on a surface of a substrate layer and heat-treated at a temperature ranging from higher than the second upper limit to lower than the first lower limit.

18. The fuel cell stack of claim 17,
wherein the first lower limit is 350° C. and the first upper limit is 380° C., and
wherein the second lower limit is 300° C. and the second upper limit is 325° C.
